(19) United States
(12) Patent Application Publication
(10) Pub. No.: US 2023/0399211 A1
(43) Pub. Date: Dec. 14, 2023

(54) Height Adjustable Platform

(71) Applicant: Michael David Brown, Northamptonshire (GB)

(72) Inventor: Michael David Brown, Northamptonshire (GB)

(21) Appl. No.: 18/032,092

(22) PCT Filed: Oct. 18, 2021
(86) PCT No.: PCT/GB2021/000116

§ 371 Date: Apr. 14, 2023

(30) Foreign Application Priority Data
Oct. 16, 2020 (GB) 2016460.4
Jun. 25, 2021 (GB) 2109220.0

(51) Int. Cl. B66F 7/06

(52) U.S. Cl. CPC B66F 7/065

(57) ABSTRACT

A manually operable height adjustable platform has a platform mounted to a base via an extensible scissor mechanism. At least one drive strut is mounted in a force path between the platform and the base and configured to bias the platform and the base away from one another via extension of the scissor mechanism. An actuation system controls movement of the platform and the base away from one another under the biasing force, where the actuation system has a manual actuator operatively connected to a pinion on one of the platform and scissor mechanism/base configured to engage a rack on the other of the platform and scissor mechanism/base. A manual actuator mounted above the platform operates the actuation system by an operator in normal use, and an override mechanism mounted below the platform acts on the drive strut for lowering of the platform without actuation of the manual actuator.

### CROSS-REFERENCE TO RELATED APPLICATION(S)

This application claims priority to United Kingdom Patent Application Serial No. GB 2016460.4, filed Oct. 16, 2020, and United Kingdom Patent Application Serial No. GB 2109220.0, filed Jun. 25, 2021, the entire disclosures of which are hereby incorporated by reference.

### TECHNICAL FIELD

The present invention relates to a height adjustable platform, particularly, to a manually actuable height adjustable platform.

### BACKGROUND

Powered, height-adjustable access platforms are well-known in the art. Electrically-powered scissor lifts and the like are used to elevate a platform on which a worker can stand to access or inspect areas above ground level. However such access platforms carry various health and safety risks and require specific training in order to be used safely.

A prior art platform is disclosed in GB2500997B, which is height adjustable by a person standing on the platform using a manual adjustment mechanism. Reference is made to features by way of numerals used in that document. The device comprises a base 12 having an upright mast 16 to which is affixed an elevatable work platform 18. The mast 16 comprises nested inner and outer housings 20,22, biased apart, i.e. to an extended condition, via a gas spring 30. The housings are moveable relative to each other by a pulley mechanism, i.e. a drive loop, operated by an external crank handle on the elevatable platform 26.

The pulley mechanism 24 comprises fixed pulley wheels 34,36 located on an inner face of outer housing 22, and a toothed a drive belt 38 passes around wheels 34, 36 and is fed between drive cog 40 and guide wheel 41 pivotally located on housing 22. The belt 34 is fixed to the inner housing at 42. The crank handle 26 is operatively connected to the drive cog 40, and during rotation of the handle 26, the belt 34 is driven over the cog 40. This allows the gas spring to extend, i.e. using the handle 26 to selectively release the gas spring in a controlled manner, thereby driving the outer housing 22 relative to the inner housing 20 and raising the platform 18. To lower the platform 18, the handle 26 is rotated in an opposing direction, thus winding the belt back in the opposing direction and bringing the masts back together against the resistance of the gas spring.

The inventor has found numerous drawbacks with the prior art.

Should the operator of the platform become incapacitated, for example, due to a medical condition or electrocution, the platform may need to be lowered so that the operator can receive medical attention. In the prior art device, a pole is provided (not shown). The pole comprises a gripper or latch configured to grasp the crank handle 26 in order to allow someone on the ground to rotate the handle 26 using the pole and manually lower the platform 18. However, due to the height of the platform 18, it may be very difficult for an operator on the ground to engage the crank 26 with the handle and provide rotation thereof. For example, in confined environments, this may be difficult or even impossible, as the crank 26 may be inaccessible due to close proximity to a wall or other obstruction. In other scenarios, an incapacitated user on the elevated platform may inhibit access to the handle 26, e.g. being slumped over the handle.

In some instances, an operator may be forced to climb up to the platform, which may expose them to a significant risk of falling, toppling the device or being electrocuted, etc. Furthermore, it has been found that, even if the platform can be lowered by an operator on the ground during an emergency, when the operator is removed from the platform in a partially lowered state, the reduced weight on the platform can lead to the platform starting to rise again under the bias of the gas spring. This is highly problematic if an incapacitated operator is only pulled part-way from the platform since the platform can start to rise whilst the operator's limbs or torso remain on the platform.

It has been found that a point of weakness resides in the handle 26 itself, which has a sprung latch to enable selective connection and disconnection of the handle 26 from the drive train. A failure of this simple mechanism can thus lead to a loss of control of the platform elevation mechanism.

The flexible drive belt 38 may be prone to jamming, wear or fraying, thus increasing the risk of the belt 38 failing. Failure/release of the mechanism would result in the platform 18 shooting up in an uncontrolled fashion, with no means for lowering the platform. Obviously, this may post a significant danger to the operator if standing on the platform.

Using the mast system of GB2500997B means that the maximum height the platform can achieve is less than double the height of the mast when lowered. The platform will typically be required to fit through a conventional doorway when lowered, i.e. to allow normal movement around a site, and so the maximum height achievable by the platform may be insufficient. The operator may climb onto the railing surrounding the platform 18, for example, to increase their reach or height whilst on the platform. This may increase the likelihood of the operator falling out of the railings and suffering injury.

When the platform is raised, the centre of gravity of the device raised. This may pose issues in windy environments, or where the ground is uneven and/or unstable.

It has also been found that an operator may move the platform when the platform 18 is in the lowered position whilst the operator is standing thereon. This is sometimes referred to as “surfing” and occurs because the operator does not want to have to disembark the platform fully before moving the platform to a new location. These issues may increase the chance of the device toppling and/or otherwise cause unsafe situations for the operator or others in the vicinity.

The safety of the operator and/or other workers is paramount in the construction/warehouse industry. Therefore, it is an aim of the present invention to overcome or ameliorate one or more of the above problems, e.g. to provide a manually height adjustable platform offering increased safety features.

### SUMMARY

According to a first aspect, there is provided a manually operable height adjustable platform comprising: a platform moveably mounted to a base via an extensible mechanism; at least one drive strut mounted in a force path between the platform and the base and configured to bias the platform and the base away from one another; and an actuation system configured to control movement of the platform and the base away from one another under the biasing force applied by the drive strut; where the actuation system comprises a manual actuator on the platform configured to vary the extension of the extensible mechanism.

The actuation system may extend between the platform and extensible mechanism or base.

The actuation system may comprise a manual actuator operatively connected to a pinion on one of the platform and extensible mechanism (or base) configured to a engage a rack on the other of the platform and extensible mechanism (or base).

The extensible mechanism may be a scissor mechanism. The scissor mechanism may comprise a series of linkages.

The extendible mechanism may extend by a distance that is greater than the extension of the drive strut, e.g. a multiple of the linear extension of the drive strut.

The actuation system may extend between the platform and a link of the scissor mechanism. The actuation system may extend between the platform and an upper, or second-to-upper, link of the scissor mechanism. The actuation system may control/limit the spacing between the link and the platform. The actuation system may be extendable to control/limit the spacing between the link and the platform and/or the spacing between adjacent links of the scissor mechanism. The actuation system may control/limit the spacing between the upper link and second-to-upper link of the scissor mechanism.

One end of the drive strut may be fixed in position relative to the scissor mechanism, e.g. a linkage of the scissor mechanism. An opposing end of the drive strut may be translatable relative to the scissor mechanism.

The actuation system may release the drive strut, e.g. in a controlled/gradual manner. The actuation system may allow manual release/extension of the drive strut and/or manual retraction of the drive strut, e.g. against the drive force of the drive strut.

The drive strut may be biased under fluid pressure. The drive strut may be continually biased under fluid pressure. The drive strut may comprise a piston and cylinder arrangement. Fluid in the cylinder may be compressible by the piston. Fluid pressure in the drive strut or cylinder thereof may be increased/decreased by operation of the actuation system.

The height adjustable platform, the drive strut and/or actuation system may be devoid of electrical power, e.g. at least for controlling raising/lowering of the platform.

The gas struts may comprise gas springs. The gas struts may comprise a fixed internal mass of gas, which is compressible/expandable under compression/extension of the strut.

According to a second aspect of the invention, there is provided: a manually actuable height adjustable platform comprising: a platform mounted to a base via an extensible scissor mechanism; at least one drive strut mounted in a force path between the platform and the base and configured to bias the platform and the base away from one another via extension of the scissor mechanism an actuation system configured to control movement of the platform and the base away from one another under the biasing force applied by the drive strut; a manual actuator mounted above the platform for operating the actuation system by an operator in normal use; and an override mechanism mounted below the platform and configured to act on the drive strut for lowering of the platform without actuation of the manual actuator.

The drive strut may comprise a biasing force and override mechanism may be configured to disengage/interrupt a portion of the force biasing force.

The gas strut may be depressurised/drained. At least one end of the gas strut may be disconnected/detached.

According to a third aspect of the invention, there is provided a height adjustable platform comprising: a platform moveably mounted to a base via an extensible mechanism; the platform having a railing arrangement configured to enclose at least a majority of a perimeter of the platform, the railing arrangement comprising at least one top rail extending around the perimeter of the platform and a plurality of intermediate rails extending downwardly from the top rail towards the platform, wherein all intermediate railings are oriented in a substantially upright orientation relative to the platform.

The railing arrangement preferably does not comprise any substantially horizontal railings between the top rail and platform, e.g. upon which a user could stand. The railing arrangement may comprise only the top rail and

The railing may enclose two or three sides of the platform. The railing may enclose a majority or all of a periphery of the platform. The railing may comprise one or more door, e.g. a pair of saloon doors. The door(s) may open inwardly towards the platform and may be inhibited from opening outwardly.

At least one intermediate rail may be releasably attached to the top rail and/or platform. A plurality of intermediate rails may be releasably attached. The releasable intermediate rail(s) may be located part way along a side of the platform perimeter. The rail(s) may be releasable in an emergency e.g. to allow access to the platform.

According to a fourth aspect of the invention, there is provided a height adjustable platform comprising: a moveable platform; the platform having a railing arrangement configured to enclose at least a majority of a perimeter of the platform, the railing arrangement comprising at least one top rail extending around the perimeter of the platform and a plurality of intermediate rails mounted between the top rail and the platform, wherein at least one of the intermediate rails is disconnectable from the railing arrangement.

The platform may be movably mounted to a base via extensible mechanism.

The intermediate railing may be disconnectable from one or both of the platform and the top rail.

One or both of the platform and the railing arrangement may comprise a mounting arrangement to provide release connection of the intermediate railing. The mounting arrangement may comprise a flange/bracket. A pin or the like may be configured to extend through the flange/bracket and the intermediate railing to provide a connection therebetween.

The pin may be connected to the platform and/or railing arrangement via a flexible member (e.g. a cable).

One of the intermediate railing and the railing arrangement/platform comprises a protrusion (e.g. dowl) configured to be received in a recess in the other of the intermediate railing and the railing arrangement/platform to provide a connection therebetween.

Further optional features of various aspects of the invention are defined in the appended claims. Any optional features defined herein in relation to any one aspect may be combined with any other aspect of the invention where practicable.

### BRIEF DESCRIPTION OF THE DRAWINGS

Workable embodiments of the invention are described in further detail below with reference to the accompanying drawings, of which:

FIG. 1 shows a side view of lift system in an extended state;

FIG. 2 shows a side view of the lift system in a collapsed state;

FIG. 3 shows an exploded view of the lift system;

FIG. 4 shows a perspective view of an actuation system of the lift in a collapsed state;

FIG. 5 shows a perspective view of an actuation system in an extended state;

FIG. 6 shows a side view of a gearbox of the lift system;

FIG. 7 shows a perspective view of the gearbox;

FIG. 8 shows a sectional side view of the gearbox;

FIG. 9A shows a perspective view of an override/release mechanism of the lift system;

FIG. 9B shows an example of an override/release mechanism in isolation;

FIG. 10 shows a side view of a base of the lift system; and

FIG. 11 shows a perspective view of a platform of the lift system;

### DETAILED DESCRIPTION

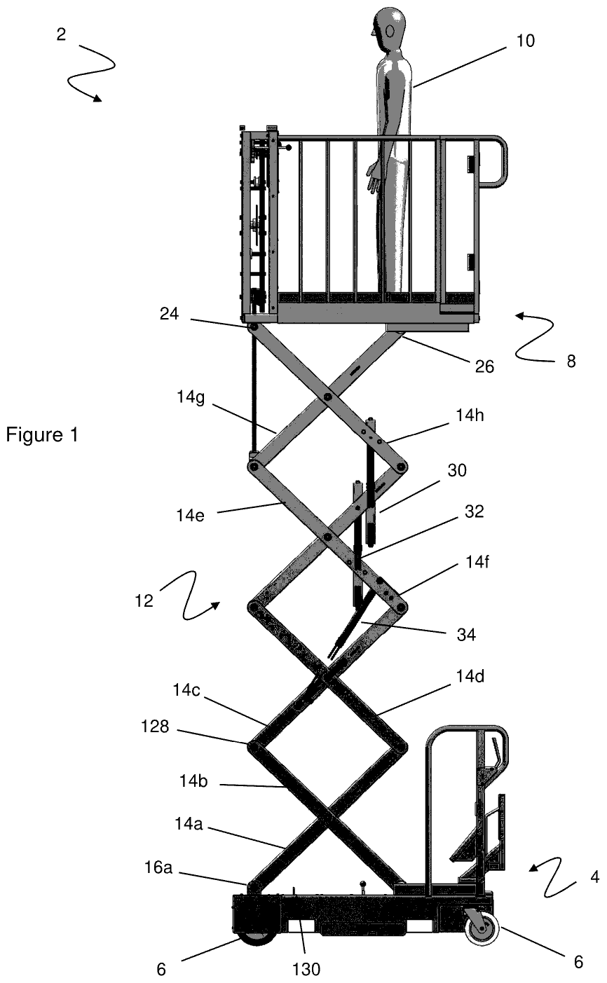

A height adjustable platform lift 2 is shown in FIG. 1. The lift 2 comprises a base 4. The base 4 is configured to support the lift 2. The base 4 comprises a plurality of wheels 6. The lift 2 is therefore portable. The wheels 6 are provided on respective corners of the base 4. However, it can be appreciated the wheels 6 may be provided in any suitable configuration. The lift 2 may moved by manpower alone (i.e. by pushing of the lift 2). In some embodiments, the lift 2 may have a motor to provide propulsion thereof.

A platform 8 is mounted to the base 4. The platform 8 is adjustable in height/elevation relative to the base 4. An operator 10 on the platform 8 may therefore be able to reach/work at a plurality of different elevations. The platform 8 is supported in a height-adjustable manner on the base 4 by a scissor mechanism 12. The scissor mechanism 12 helps ensure the platform 8 is supported in its level orientation relative to the base during height adjustment.

The scissor mechanism comprises a plurality of pivoting arms or linkages 14, referred to herein below as beams 14. The scissor mechanism comprises a first beam 14a pivotally mounted to the base 4 at a first end 16a thereof. A second beam 14b is pivotally mounted to the first beam 14a about the respective midpoints thereof. The beams 14a,b, are thus arranged in an X-shape.

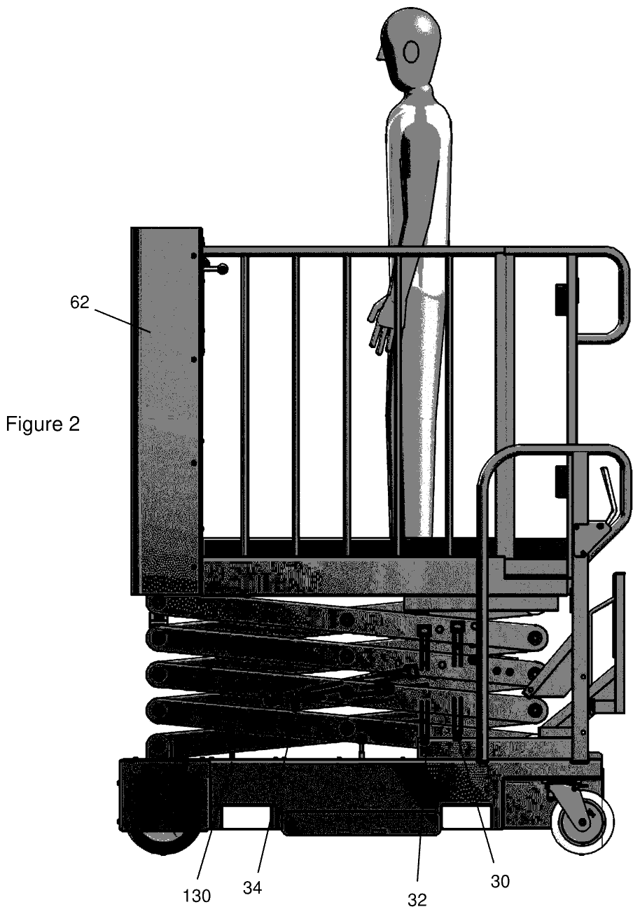

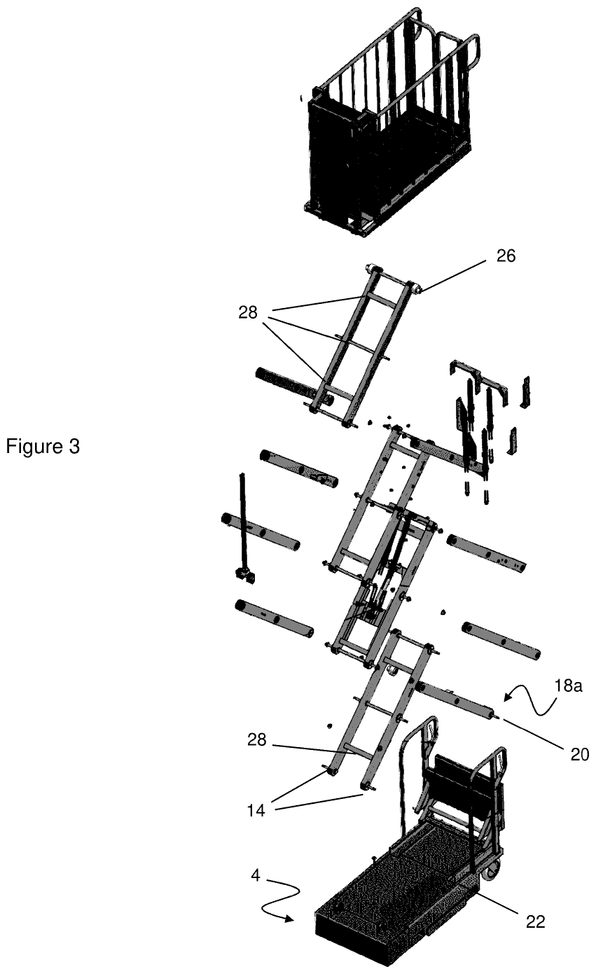

A first end 18a of the second beam 14b is slidably fixed to the base 4. The first end 18a comprises a pin 20 (see FIG. 3) configured to be received within a channel 22 on the base 4. A wheel/roller or the like may be mounted on the pin 20 to aid with movement within the channel 22. The scissor mechanism 12 is therefore collapsible (see FIG. 2), to allow effective variation of the length thereof.

Furthers beams 14c-h are provided in similar X-shaped units. In the present embodiment, fours such units are provided. However, it can be appreciated any number of units may be provided to allow any height extension as required. An end 24 of an uppermost beam 14h is pivotally attached to the platform 8. An end 26 of a second uppermost beam 14g comprises a similar pin/channel arrangement to the second beam 14b. As best seen in FIG. 3, each beam 14 comprises a parallel beam. The parallel beams are joined by links 28. The links 28 extend perpendicular to the beams 14. The links 28 may provide the pivoting midpoint.

The scissor mechanism 12 is biased into an extended position. One or more gas strut is used to bias the scissor mechanism away from a collapsed condition, e.g. in which the beams/arms 14 lie generally atop one another, to an extended condition in which the angle between adjacent arms/beams is increased. The interior angle formed at the pivot/pin joints of the scissor mechanism between adjacent beams is thus opened/increased in the extended condition. The angle is approximately perpendicular as shown in FIG. 1, although a greater or lesser angle may be achieved in a fully extended condition according to the relevant engineering and safety considerations.

A plurality of gas struts 30, 32, 34 are used to bias the scissor mechanism in the example shown. The different gas struts act on different pairs of adjacent beams of the scissor mechanism, although two or more gas struts can additionally/alternatively act on the same pair of adjacent beams as will be described below. The gas struts act in parallel to bias the scissor mechanism open.

A first gas strut 30 extends beams 14f and 14g. The gas strut 30 is mounted under compression, and thus acts bias the beams 14e,h away from one another, extending the scissor mechanism 12. A second gas strut 32 is mounted between two beams 14e and 14f. The second gas 32 strut is substantially the same as the first gas stut 30. A third gas strut 34 is mounted between beams 14f and 14c. The third gas strut 34 will be described in detail later.

It can be seen that the gas struts are mounted in series, thus providing substantially continuous force path between beam 14h and beam 14c. The force path extends along the axis of scissor mechanism (i.e. the direction of extension/retraction of the mechanism). Although the gas struts are mounted in series between different links of the scissor mechanism arrangement, they act in parallel to drive elevation of the platform.

The gas struts 30,32,34 are also mounted in parallel pairs (see FIG. 3) in the example shown. The system thus comprises six gas struts in total. It can be appreciated that any suitable compression biasing means may be used in lieu of the gas struts/spring, for example: hydraulic spring; mechanical springs; torsion springs etc. In some embodiments, the springs may be mounted under tension. For example, the spring may extend between beams 14e and 14f, drawings the ends of the beams together, and thus providing extension of the scissor mechanism 12. The gas struts 30,32,34 are arranged such that they do not collide with one another when the scissor mechanism is collapsed (see FIG. 2).

Gas struts 30,32 are configured to extends in a vertical direction. The gas struts 30,32 thus provide a biasing force substantially parallel to the direction of the extension of the scissor mechanism. Gas strut 43 is provided at angle relative to the vertical, e.g. obliquely. The gas strut thus provides a biasing force substantially at angle relative to the direction of the extension of the scissor mechanism. This reduces the biasing force of the gas strut 34, i.e. such that only a component of the total force applied by the gas strut(s) acts in the direction of extension of extension of the scissor mechanism. The angle between the extension direction of the gas strut and the extension direction of the scissor mechanism is between 20 and 45 degrees in this example.

In the example where one or more obliquely angled gas strut is provided, said gas strut(s) may be selectively disengagable/releasable from the force path with the scissor mechanism so as to provide a release mechanism for lowering the platform as will be described in further detail below.

The biasing force of the biasing mechanism (i.e. gas struts 30,32,34 acting in concert) is approximately equal to the weight of platform 8. Thus in normal use, the platform 8 will be essentially weightless and the platform 8 will remain in a constant vertical position if unperturbed. In some embodiments, the biasing of force is greater than the weight of the platform 8. The biasing force can therefore accommodate a load on platform 8 (e.g. the weight of the operator 10). In some embodiment, the biasing of force is less than the weight of the platform 8. This may prevent accidental extension of the scissor mechanism 12. The biasing force is greater than or equal to 50% of the weight of the platform; preferably greater than or equal to 70%; preferably, greater than or equal to 90%.

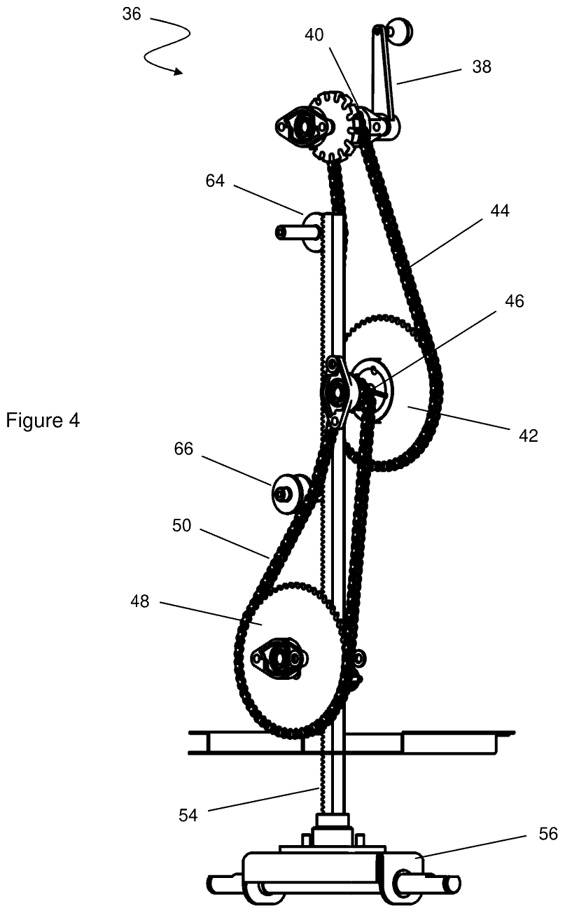

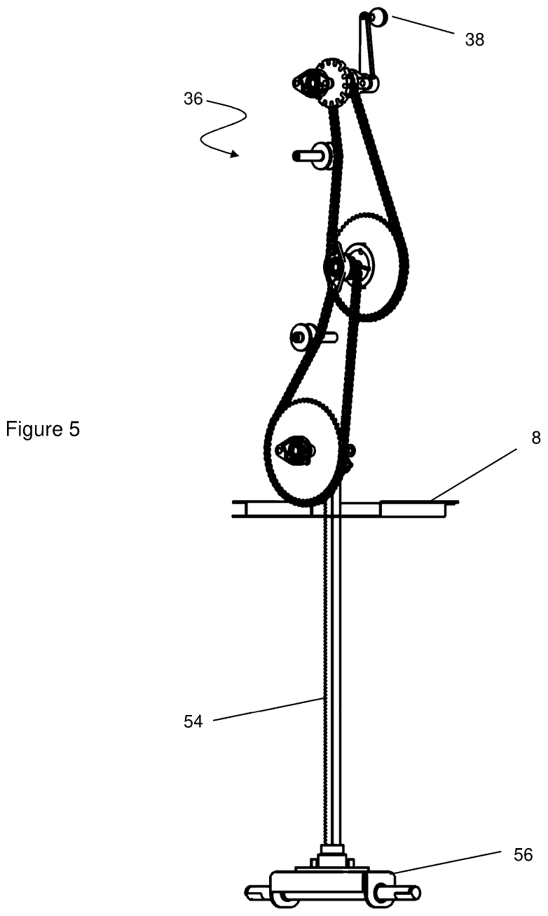

An actuation system to allow manual raising/lowering of the platform by the operator is provided by way of mechanism 36, referred to herein as a actuation or driving mechanism. The driving mechanism 36 is shown in closer detail in FIGS. 4 and 5. The driving mechanism 36 comprises a manual actuator (i.e. handle 38). The handle 38 is configured to allow manual actuation of the mechanism 36. The handles 38 operatively connected to a first gear 40. The handle is mounted to a spindle/shaft of the first gear 40. The handle 38 is thus rotatable to drive the first gear 40.

The first gear 40 is connected to second gear 42 via a chain 44. The second gear 42 is larger than the first gear 40, thus providing a reduction gear. A third gear 46 is mounted coaxially with the second gear 42. The third gear 46 is smaller than the second gear 42. The second gear is operatively connected to fourth gear 48 via a second chain 50. The fourth gear 48 is larger than the third gear 46, thus providing a reduction gear. The gears 40, 42 and 48 are connected in serial. The gears thus 40,42,48,48 collectively define a gearbox. The gearbox provides a reduction gear.

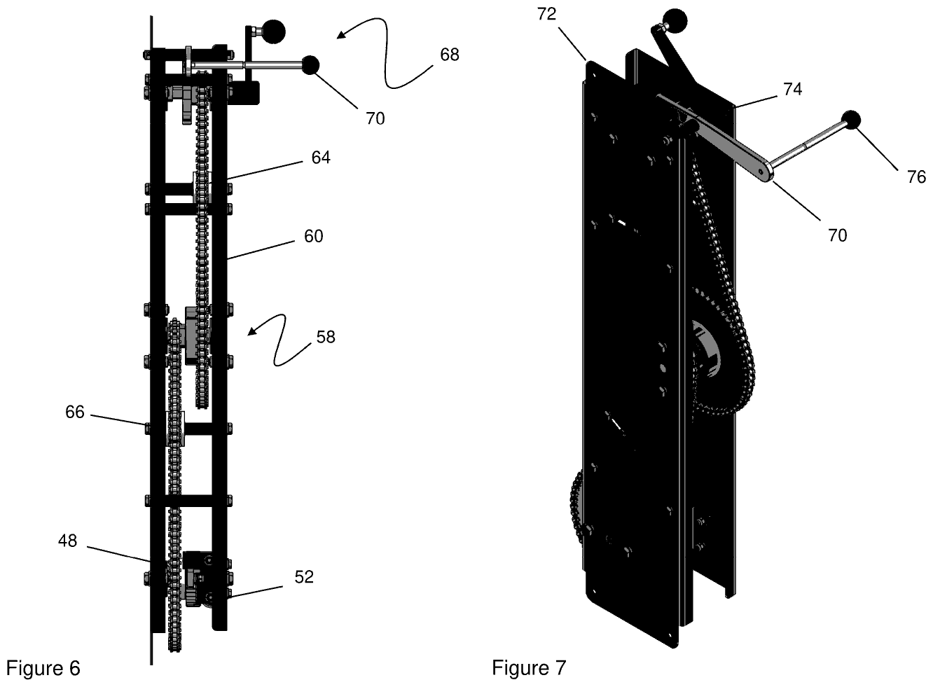

A fifth gear 52 (see FIG. 6) is mounted coaxially with the fourth gear 48. The fifth gear 52 engages a toothed rack 54. The fifth gear 52 provides a pinion. The driving mechanism 36 provides thus a rack and pinion mechanism. The toothed rack is straight/linear. An end 56 of the rack 54 is fixed to the scissor mechanism 12. The end 56 is pivotally attached at the pivot joint between beams 14g and 14f. The rack 54 thus extends in substantially vertical direction in use. It can be appreciated that the rack 54 may be attached to any suitable point on the scissor mechanism. For example, where the pivot joint between beam 14g and 14e extends laterally beyond the rack 54, the rack 54 may be fixed to any portion of the beam 14g.

It can be seen that rotation of the handle 38 causes extension of the rack 54 relative to the gearbox, and therefore the platform 12. This drives beam 14g away from the platform 12, in turn, extending the scissor mechanism 12. The gearbox reduces the force needed to turn the handle 38 and raise/lower the platform 12. Depending on the exact configuration, operation of the driving mechanism, acts with or against the biasing force of the biasing mechanism. However, the biasing mechanism ensures the force required to raise/lower the platform 12 is reduced.

In some embodiments the rack 54 is fixed to base 4. This option may be suitable where the vertical adjustment height is relatively small. It can be appreciated that attaching the rack 54 to the scissor mechanism 12 the rack 54 can be contained with the vertical profile of the platform 8, thus reducing the height of the system in a collapsed state.

Referring to FIGS. 6 and 7, the gearbox comprises a support structure 58. The support structure 58 at partially contains or houses the gearbox. The support structure 58 comprises a pair of spaced plates 60. The gears 40,42,48,48 are mounted to and between the plate 60. A further housing 62 (see FIG. 2) encloses the support structure 58. This prevents damage to the gearbox and/or prevents the operator contacting the gearbox. The first chain 44 and the second chain 50 comprises a respective tension wheels 64,66. The tension wheels 64,66 engage the chains 44,50 to ensure they remain in tension on the respective gears. The tension wheel 64,66 are fixed to the support structure 58.

The rack 54 may engage one or more runners mounted on the support structure. The runners may comprise a freely rotating wheel/gear. The runners may be provided axial along the rack 54 from the pinion gear 52 (i.e. in a vertical direction). This may help to prevent wobbling of the platform 12. The rack 54 may be fully contained within the support structure 58 and/or housing 62 in the collapsed position.

The drive mechanism 36 comprises a locking mechanism 68. The locking mechanism 68 is configured to engage the driving mechanism 36, thereby preventing rotation thereof. The locking mechanism 68 thus retains the platform 8 in a fixed position/elevation.

The locking mechanism 68 comprises a manual actuator 70 (e.g. a handle). The handle 70 is provided at the upper end 72 of the support structure 58. The handle 70 is pivotally mount to the support structure via a pivot 74. The handle 70 thus provides a lever or the like. The handle 70 is generally L-shaped. The handle 70 comprises a grip member 76. The grip member 76 comprises a knob/bulb.

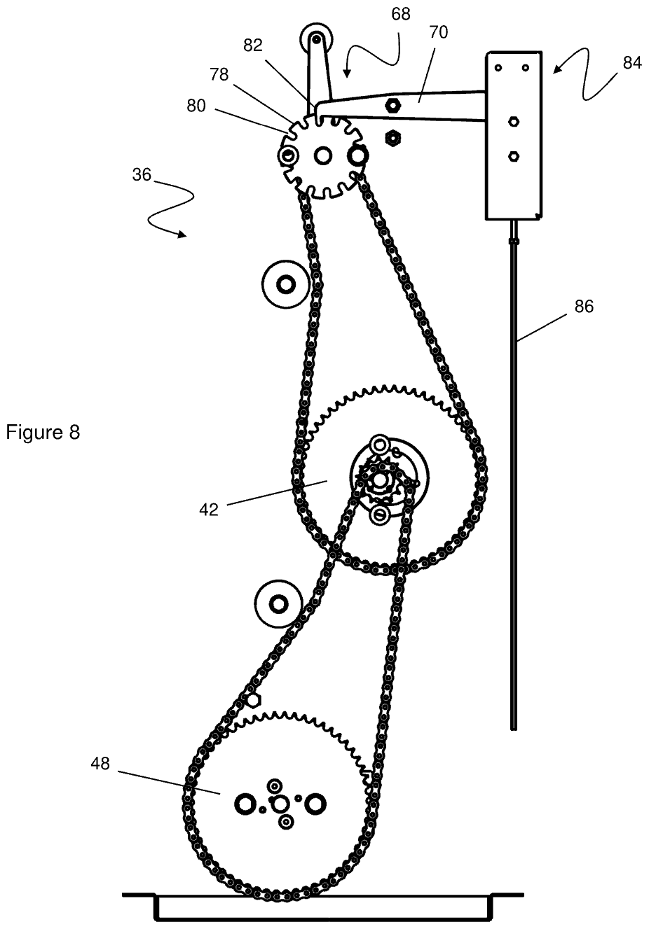

As best seen in FIG. 8, the handle 70 is configured to engage a gear 78 driving mechanism 36. The gear 78 is mounted coaxially with the drive cog 40. The gear 78 comprises a plurality of grooves 80 configured to receive a flange 82 on the handle 70. The handle 70 can therefore be pivoted in and out of engagement with the gear 78. This, in turn prevents/allows rotation of the gear 78 and the drive cog 40, thereby preventing/allowing movement of the platform 12.

The locking mechanism 68 is biased into a locked position (i.e. biased into engagement with the drive mechanism 36). The locking mechanism may be actively biased via a biasing mechanism (e.g. a torsion spring), or may be biased by the weight of the actuator 70. The driving mechanism is therefore prevented from effecting movement of the scissor mechanism in a default configuration. The operator must therefore release the locking mechanism 68 to allow movement of the platform 8. As the locking mechanism 68 is biased into the locked position, the operator must continually disengage the locking mechanism 68 during height adjustment of the platform. This requires the operator to use both hands to adjust the platform heigh (i.e. one hand for the elevation handle 38 and one for the actuator 70). This reduces the change of accidently height adjustment and/or ensures the operators arms are within the platform boundary during movement thereof.

The locking mechanism 68 comprises a release mechanism 84. The release mechanism 84 allows release of the locking mechanism 68 from a position distal the platform 12. For example, if the operator is incapacitated on the platform 12, the release mechanism 84 allows lowering of the platform 12 without the need to actuator the handle 70. The release mechanism 84 comprises a tension member 86 (e.g. a cable or the like). The tension member 86 is operatively connected to the handle 70, such that upon actuation of the tension member 86, the handle 70 disengages from the gear 78.

The distal end of the tension member 86 is connected to a manual actuator. The manual actuator is provided at a location generally accessible by an operator on the ground. For example, actuator is provided on the base 4. Alternatively, the manual actuator is provided on the scissor mechanism at a position accessible from the ground at any extension of the scissor mechanism (e.g. at point 128 in FIG. 1). The manual actuator is thus placed a point less than or equal to 2.5 m from the ground; preferably, less than or equal to 2 m; preferably, less than or equal to 1.8 m.

An additional/alternative release mechanism 85 (which may be considered to provide an override mechanism) is further configured to interrupt the force path acting between one or more of the gas struts 30,32,34 and the scissor mechanism. Unlike the release mechanism 84, which permits/prevents use of the manual actuation mechanism, the release mechanism 85 inhibits normal use of the platform by ensuring that the biasing force provided by the gas struts is insufficient to maintain the platform in a raised/elevated condition. This causes the platform 12 to lower itself under the bias of its own weight. By releasing only one or some of the gas struts, the platform can safely lower itself in a controlled manner under the resistance of the remaining gas struts.

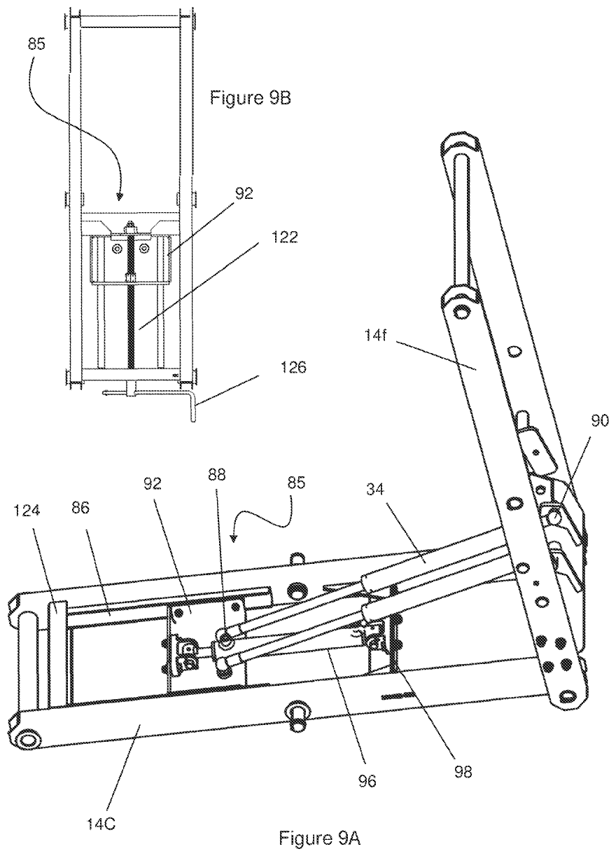

As shown in FIG. 9A, a first end 88 of the third gas strut 34 is movably mounted to beam 14c. The second end 90 is pivotally mounted to beam 14f (albeit in a fixed position). The first end 88 is pivotally mounted to a carriage 92. The carriage 92 is movably/slidably mounted to the beam 14c. The carriage 92 is mounted via a guide/track 94 in this example. The guide 94 extends along the axis of the beam 14c. The carriage 92 therefore slides along the length of the beam 14c. In other examples, the carriage could pivot or otherwise move differently to permit extension of the gas strut 34.

The moving carriage means that the gas strut 34 can be extended fully without acting to extend the scissor mechanism. This effectively disengages the gas strut 34 from the force path by permitting increased length of the gas strut.

The carriage 92 is located in the space between the pair of beams 14c in this example.

The carriage 92 is operatively connected to the beam 14c via a damper 96. The damper 96 comprises a hydraulic damper. A first end of the damper 96 is fixed to the carriage 92. The opposing end is fixed to a lateral beam 98 extending between the pair of beams 14c. The damper 96 thus damps movement in the sliding direction of the carriage 92. The carriage 92 comprises a locking mechanism configured to hold/release the carriage relative to the beam 14c. The locking mechanism may be operatively connected to the tension member 86. Additionally or alternatively the carriage locking mechanism may be connected to separate actuator than the drive mechanism release mechanism 84. The carriage locking mechanism may comprise a pin or like biased into engagement with the carriage. In other embodiments, the carriage locking mechanism comprises a friction brake or ratchet.

Upon actuation of the release mechanism 84/85, the drive mechanism 36 is disengaged and the carriage 92 is movable relative to the beam 14c. The biasing force of the third gas strut 34 is thus directed into the moving the carriage against the damper 96. This reduces the biasing force holding up the platform 12, and the platform 12 is lowered under gravity. The remaining gas struts 30,32 and the damper 96 ensure the platforms descends at a safe rate.

It can be appreciated that release mechanism 85 may be configured to interrupt the force path of any one or combination of the gas struts 30,32,34. In the example shown, the release mechanism acts on the obliquely angled gas strut(s) 34, e.g. the gas struct(s) making a smaller contribution to the extension force on the scissor mechanism.

In some embodiments, the damper 96 may not be required, as the remaining struts provide a damping force. In some embodiments, the gas strut(s) 30,32,34 may merely disconnect or detach from the respective beam 14 (i.e. no carriage is provided). The gas strut(s) can then be reconnected to resume normal use of the system. In some embodiments, the release mechanism 84 is configured to permit egress of fluid from (i.e. drain) one or more gas strut, thereby reducing or removing the biasing force. The gas may then be replenished to reset the system.

In an alternative embodiment of the release mechanism 85 shown in FIG. 9B, movement of the carriage 92 is effected via an actuator 120. The actuator comprises a screw/worm drive. The screw drive comprises a threaded shaft 122 fixed to the carriage 92. The thread shaft 122 is received is received within a threaded aperture in a portion 124 of the scissor mechanism. Typically, the portion 124 may be provided by a cross-beam 28. The actuator comprises a handle 126 to provide manual actuation thereof. In some embodiments, the actuator 120 may be driven via a motor or like.

The screw/worm drive of FIG. 9B may be used to release and re-engage the gas struts as necessary. In the example of FIG. 9B linear guides for the carriage are provided in the form of pins/columns instead of the rails 86 of FIG. 9A.

In some embodiments, the actuator 120 and the damper 96 may both be provided.

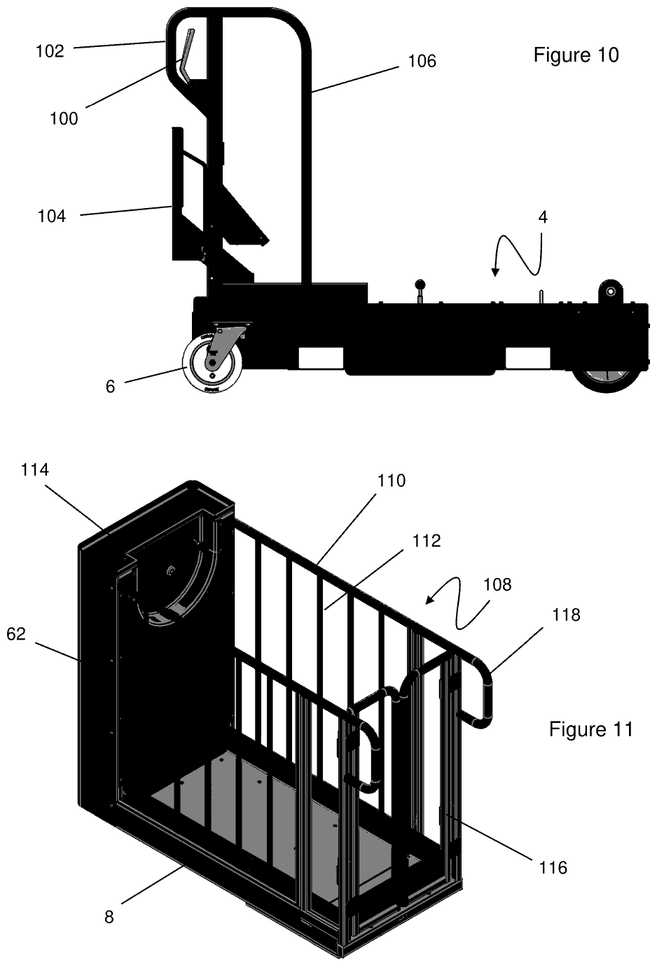

As best seen in FIG. 10, the lift 2 comprises a braking system configured to prevent undesired movement thereof. The braking system comprises brake is configured to engage wheel 6 in a default position (e.g. the brake is biased into a braking position), thereby preventing movement of the lift 2. The brake is connected to lever 100 or the like configured to be actuated to disengage the brake (e.g. via a cable). The brake lever 100 may be provided on a handle 102 connected to the base 4. The brake therefore is only operable (i.e. to disengage the brake) when by a user on the ground. This prevents “surfing” of the lift 2.

During manual movement of the system by the operator, the operator is required to manually disengage the brake to allow movement of the lift 2. The brake must remain disengaged during movement of the lift 2 (i.e. the operator continually holds the lever). Once the operator has finished moving the lift 2, the operator releases the brake, and the brake re-engages the wheel 6 to prevent movement of the lift 2.

In some embodiments, a further braking system is configured to prevent movement of the base 4 when the platform 8 is an elevated position. This may prevent “surfing” of the lift 2. The braking system be configured to engage one or both wheels 6 on the base 4. The braking system may comprise a resilient pin or button 130 on the base 4 (see FIG. 1). When the scissor mechanism 12 is lowered, one of the beams 14 or any suitable portion of the mechanism 12 engages the pin 130. Typically, the brakes are biased into an engaged position with the wheel, and when pin is engaged/moved, the brake is disengaged from the wheel via a mechanical linkage therebetween (e.g. a cable or lever etc.). Therefore, when the pin 130 is engaged, the brakes are disengaged, allowing movement of the base. Conversely, the when the pin 130 is not engaged, the brakes are engaged with the wheels. The brakes are thus engaged when the platform is lowered and disengaged when the platform is raised. It can be appreciated that pin 130 arrangement is merely exemplary and any suitable arrangement may be used, for example; an electronic mechanism (e.g. using optical or pressure sensors); a cable mechanism (e.g. a cable on a pulley is pulled into tension when the platform is elevated); or the brake may be rotated into/out of engagement with the wheel 6 when beam 14a/b is rotated toward/away from the base 4.

The base 4 comprises a step arrangement 104 configured to allow the operator to climb from ground onto the platform 8 when in the lowered position. A railing arrangement 106 is provided adjacent the step arrangement 104. The railing 106 ensures the operator maintains “three points of contact” whilst climbing the steps 104, thus ensuring safety of the user. The brake lever 100/handle 102 are provided on or adjacent the railing 106. The brake is provided on one or both of the wheels 6 adjacent the step 104. The wheel 6 may be freely rotatable about a vertical axis in use.

The step arrangement 104 is rotatable relative to the base 4 to allow stowing thereof when not in use. For example, this may prevent unauthorised persons accessing the platform 8 and to provide a compact configuration. The steps 104 are connected to the base via hinge or the like. The steps 104 may rotate by substantially 90 degrees (i.e. about a horizontal axis). The steps 104 therefore may be contained within the footprint of the platform 8 when raised.

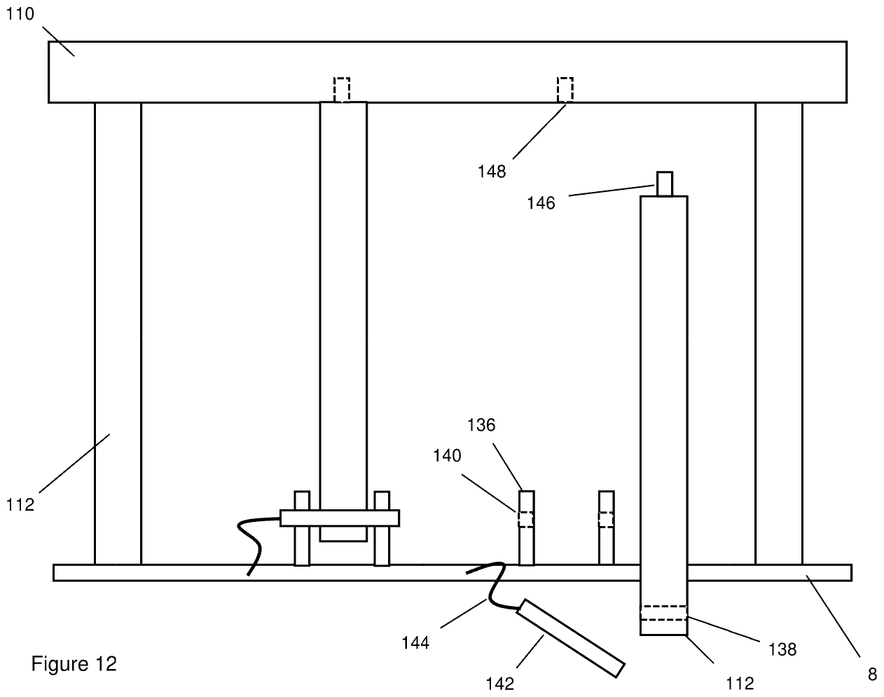

Referring to FIG. 11, the platform 8 comprises a plurality of railings 108 which surround the platform 8, thus defining a cage like arrangement. The railings 108 comprise a top railing 110, provide at an uppermost end of the cage. A plurality of intermediate railings 112 extend between the platform 8 the top railing 110. The intermediate railings 112 are provided in a substantially vertical orientation, thereby preventing the operator from standing thereon. The platform 8 therefore does not comprise any horizontal railings on which the user can stand.

In this respect, it has been found that users attempt to gain additional elevation on conventional platforms, i.e. which do not quite achieve a desired elevated height, by climbing on the railings. This causes significant health and safety concerns. A partial solution to this problem is provided by the additional height extension afforded by the elevation mechanism described herein, which can offer an elevation gain that is a multiple of the extension length of the gas spring(s). A different solution to this problem, which can be used with or without the elevation mechanism described herein, is provided by the modified railing system. Accordingly, aspects of the invention provide a manually height adjustable platform, the platform comprising a railing arrangement configured to at least partially enclose the platform, the railing arrangement comprising at least one top rail and a plurality of intermediate rails extending downwardly from the top rail towards the platform, wherein all intermediate railings are oriented in a substantially vertical direction and/or where the railing arrangement does not comprise any substantially horizontal railings between the top rail and platform that an operator may stand on.

It has been found that, provided the intermediate railings are all generally upright, e.g. forming an angle of greater than 70°, 80° or 85° with respect to the platform, then a user will typically not attempt to climb on them. Furthermore, it has been found that a user will be dissuaded from trying to stand on a top rail alone since there is not higher rail that a user can grip by hand whilst climbing.

For example, provided the top rail is at or above 0.9 m, 1.0 m, 1.1 m or 1.2 m in height, e.g. being at or above waist height of the user, then a user will not typically attempt to climb thereon without any additional supporting handrail or foot rail available that is spaced from the top rail.

A tray 114 is mounted on the platform 8. The tray 114 therefore allows convenient access for the operator for fasteners, components etc. The tray 114 may form part of the support structure housing 62.

The platform 8 comprises a plurality of rotatable doors 116 configured to selectively to selectively allow access to the platform 8. The doors 116 are rotatably mounted to the railings 108 and/or the platform 8. The doors 116 are configured to rotate inwards over the platform 8 and/or prevented from opening in an outwards direction. This reduces the likelihood of the user falling from the platform, for example, if they lean on the doors 116. Handles 118 may be provided adjacent the doors 116.

In some embodiments, the doors 116 may be configured to prevent opening thereof during elevation of the platform 8. This may prevent the operator from opening the doors 116 whilst in an elevated position. This may be achieved by mounting the doors 116 to the platform via a weight dependent hinge or bearing. Such a hinge/bearing prevents relative movement when a predetermined force is transferred therethrough. The predetermined force will typically be weight the doors 116 or at least significant portion thereof (e.g. greater than or equal to 50%). When the platform 8 is in the lowered position, at least a portion of the weight of the doors 116 is supported on platform 8 and/or the base 6. For example, the baser 6 may comprise a protruding member configured to engage the doors 116 in the lowered position. Relative movement between the door 116 and the platform 4 is therefore permitted, and the doors 116 may be opened. In the elevated position, a least a portion of the weight of the doors 116 is borne by the hinge/bearing and the doors are prevented from opening.

In other embodiments, the doors 116 may comprises a locking mechanism. The locking may be selectively disengaged when the platform 8 is in the lower position. The locking mechanism may comprise a similar mechanism to the further breaking mechanism described above. For example, the doors 116 may be prevented from opening via a resiliently biased latch/lock. The base 4 may engage a portion of the latch/lock to provide release thereof in the lowered position.

In some embodiments, one or more of the intermediate railings 112 are removable/disconnectable from the railings arrangement 108/platform 6. This allows an operator to be removed from the platform 8 in an incapacitated state, as this may be prevented by the doors 116. The arrangement is shown schematically in FIG. 12.

The intermediate railing 112 is configured to releasably attached to the platform 8 and the top railing 110 respectively. The intermediate railing 112 is connected to the platform 8 via a mounting arrangement 134. The mounting arrangement comprises a bracket 136 configured to receive the railing 112. The brackets 136 comprise an open face to allow reception of the railing 112. The open face faces outwardly from the platform (i.e. out of the plane of the page). The bracket 136 may be U-shaped. The railing 112 comprises an aperture 138. Corresponding apertures 140 are provided on the bracket 136. A pin 142 or the like may therefore be passed through the apertures 138,140 to provide a connection therebetween. The pin 142 may be retained using a fastener, latch or the like. The pin 142 is connected to the platform 8 to prevent loss thereof. The pin 142 may be connected via a wire, rope, string 144 or the like.

An upper end of the intermediate railing 112 comprises a protrusion/dowl 146 configured to be received in a corresponding recess 148 in the top railing 110, thus retaining the intermediate rail 112. The dowl 146 typically provides a tight/close fit with the recess 148 to prevent unwanted movement therebetween.

In some embodiments, the bracket arrangement 136 may be used to connect the intermediate railing 112 and the top rail 110. However, the dowl 146 provides a quick release of the intermediate railing 112, and is thus preferable.

It can be appreciated that connections between the intermediate railing 112 and the platform 8 and/or top railing 110 are merely exemplary. Any suitable connection may be provided, for example, one or more of: fasteners; latches; interference fit; screw threads; resilient clips etc. The present embodiment allows removal on individual intermediate railings 112. Any or all of the intermediate railings 112 (i.e. those shown in FIG. 11) may be removable. Typically, those railings 112 provided at the corners and/or adjacent the doors 116/handle 118 are not removable.

In some embodiments, two or more intermediate railings 112 may be provided a single unit. A plurality of railings 112 may there be removed simultaneously. The plurality of railings 112 may comprise individual mounting arrangements 134 or be mounted via a single/common mounting arrangement 134. Detachable joints or the like may be provided in the top railing 110. In some embodiments, the complete railing arrangement 108 may be detachable from the platform 8.

The present invention provides a lift that is manually operated. This mitigates the need for specialist training or certification required by powered lifts. Additionally, this mitigates the need to supply power or fuel or the like, which may not easily be accessible (e.g. in building sites).

The lift provides an override mechanism to allow lowering of the platform in the event of incapacitation of the operator. The override mechanism is accessible from the ground using a simple mechanism, thereby allowing quick and safe lowering of the platform.

The lift prevents climbing or leaning from the cage surrounding the platform. The operator is prevented from entering the area beneath platform by the storage containers and/or banister arrangement. The braking system ensures the operator cannot “surf” the lift even if the platform is not elevated. The present invention therefore provides a system with numerous improved safety features.

1. A manually operable height adjustable platform comprising:
a platform mounted to a base via an extensible mechanism;
at least one drive strut mounted in a force path between the platform and the base and configured to bias the platform and the base away from one another via extension of the extensible mechanism;
and an actuation system configured to control movement of the platform and the base away from one another under a biasing force applied by the drive strut;
where the actuation system comprises a manual actuator operatively connected to a pinion on one of the platform and extensible mechanism configured to a engage a rack on another of the platform and extensible mechanism.

2. The height adjustable platform according to claim 1, where the actuation system is manually actuatable in first and second opposing directions with and against the bias of the drive strut respectively.

3. The height adjustable platform according to claim 1, where the extensible mechanism comprises a scissor mechanism and the actuation system extends between the platform and the scissor mechanism.

4. The height adjustable platform according to claim 1, where the pinion is operatively connected to the manual actuator via a gearbox having a non-unity gear ratio.

5. The height adjustable platform according to claim 4, where the gearbox comprises plurality of gears operatively connected via a tension member.

6. The height adjustable platform according to claim 5, where the gearbox comprises at least three gears sequentially connected via a respective tension member.

7. The height adjustable platform according to claim 1 comprising a locking mechanism configured to lock the platform against movement by the actuation system.

8. (canceled)

9. The height adjustable platform according to claim 7, where the locking mechanism is manually operable from a location on the platform.

10. (canceled)

11. The height adjustable platform according to claim 1, where the platform comprises a railing arrangement configured to at least partially enclose the platform, the railing arrangement comprising at least one top rail and a plurality of intermediate rails extending downwardly from the top rail towards the platform, wherein all intermediate railings are oriented in a substantially vertical direction and/or where the railing arrangement does not comprise any substantially horizontal railings between the top rail and platform that an operator may stand on.

12. (canceled)

13. (canceled)

14. The height adjustable platform according to claim 1, comprising a braking system, where the braking system is biased to a braking condition of one or more wheels provided on the base, and further comprising a manual actuator to override the bias of the braking system in order to disengage the braking condition.

15. The height adjustable platform according to claim 14, where the manual actuator of the braking system is located on the base.

16. The height adjustable platform according to claim 1, where the extensible mechanism comprises a scissor mechanism and a plurality of drive struts are provided, each of the drive struts mounted in serial between respective members of the scissor mechanism to provide extension thereof.

17. A manually actuable height adjustable platform comprising:
a platform mounted to a base via an extensible mechanism;
at least one drive strut mounted in a force path between the platform and the base and configured to bias the platform and the base away from one another via extension of the extensible mechanism;
an actuation system configured to control movement of the platform and the base away from one another under a biasing force applied by the drive strut;
a manual actuator mounted above the platform for operating the actuation system by an operator in normal use; and
and an override mechanism mounted below the platform and configured to act on the drive strut for lowering of the platform without actuation of the manual actuator.

18. The height adjustable platform according to claim 17, where the override mechanism is configured to disengage the at least one drive strut from the force path.

19. The height adjustable platform according to claim 17, comprising a plurality of drive struts, where the override mechanism is configured to disengage only one or some of the drive struts from the force path.

20. The height adjustable platform according to claim 17, where the override mechanism is configured to allow movement of at least one end of the drive strut.

21. The height adjustable platform according to claim 20, where at least one end of the drive strut is mounted to a carriage, the carriage selectively movable relative to the extensible mechanism.

22. The height adjustable platform according to claim 21, where the extensible mechanism comprises a beam and the carriage is moveable along an axial length of the beam.

23. The height adjustable platform according to claim 21, where the carriage is operatively connected to the extensible mechanism via a damper.

24. The height adjustable platform according to claim 17, where the override mechanism is configured to act on the force path of the actuation system between the platform and the base.

25. The height adjustable platform according to claim 24, comprising a locking mechanism configured to engage the actuation system to lock the platform at a given elevation and the override mechanism is configured to disengage the locking mechanism.

26. The height adjustable platform according to claim 25, where the locking mechanism comprises a locking member configured to selectively engage a gear in a gear box of the actuation system.

27. The height adjustable platform according to claim 17, where the override mechanism is actuable via a further manual actuator.

28. The height adjustable platform according to claim 27, where the further manual actuator is located on the base.

29. The height adjustable platform according to claim 17, where the extensible mechanism comprises a scissor mechanism.
